(19) United States
(12) Patent Application Publication
(10) Pub. No.: US 2006/0184394 A1
(43) Pub. Date: Aug. 17, 2006

(54) Method to display up-to-date medical information graphs

(76) Inventor: Rex Wendell Maughan, Murray, UT (US)

Correspondence Address: Siemens Corporation;Intellectual Property Department, 170 Wood Avenue South, Iselin, NJ, 08830, US

(21) Appl. No.: 11/222,089

(22) Filed: Sep. 8, 2005

Related U.S. Application Data
(60) Provisional application No. 60/653,198, filed on Feb. 15, 2005.

(51) Int. Cl. G06F 19/00

(52) U.S. Cl. 705/3

(57) ABSTRACT

A system employs a prediction processor for predicting demand for a graph and in response to receiving an individual new clinical result, observation or other information, updates associated graphs as a background process to provide a graph with reduced response time upon user request. A medical data graphing system includes a repository for storing patient medical data and an acquisition processor. The acquisition processor acquires medical data concerning a particular patient and stores the acquired patient medical data in the repository. A data processor processes the acquired patient medical data derived from the repository to provide graph representative data for storage in a repository, in response to predetermined configuration information indicating a graph is to be pre-stored for the acquired data. A user interface processor provides data representing a display image including a pre-stored graph in response to user command.

This is a non-provisional application of provisional application Ser. No. 60/653,198 by R. Maughan filed Feb. 15, 2005.

### FIELD OF THE INVENTION

This invention concerns a medical data graphing system enabling rapid update of patient medical information graphs for display or storage for subsequent access.

### BACKGROUND OF THE INVENTION

Existing systems typically create a graph of patient medical data, for example, in response to a user request to access the graph. Such a graph is created by a client or server application. A client application typically creates a graph from a complete data set downloaded to a client device. This involves communication of potentially large quantities of data to a client device prior to graph creation and the use of substantial communication bandwidth, especially in an (Application Service Provider) ASP environment. Further, the creation of a graph is often a relatively slow process and as a result a user is deterred from requesting a graph format data presentation. In a system employing a server application to create a graph, the data traffic associated with downloading a graph data set to a client device is eliminated. However graph creation still typically remains a relatively slow process often due to the very large set of data that is used in a graph. A system according to invention principles addresses these deficiencies and related problems.

### SUMMARY OF INVENTION

A system employs a prediction processor for predicting user demand for a graph in order to create and provide a graph with reduced response time upon user request. A patient medical data graphing system includes a repository for storing patient medical data and an acquisition processor. The acquisition processor acquires medical data concerning a particular patient and stores the acquired data in the repository. A data processor processes the acquired patient medical data derived from the repository to provide graph representative data for storage in a repository, in response to predetermined configuration information indicating a graph is to be pre-stored for the acquired patient medical data. A user interface processor provides data representing a display image including a pre-stored graph in response to user command.

### BRIEF DESCRIPTION OF THE DRAWING

FIG. 1 shows a system for processing and graphing patient medical data, according to invention principles.

FIG. 2 shows a user interface image presenting a patient medical graph, according to invention principles.

FIG. 3 shows a user interface image presenting a patient medical graph in the event that an up to date graph is unavailable, according to invention principles.

FIG. 4 shows a flowchart of a process for providing a patient medical graph, according to invention principles.

### DETAILED DESCRIPTION OF THE INVENTION

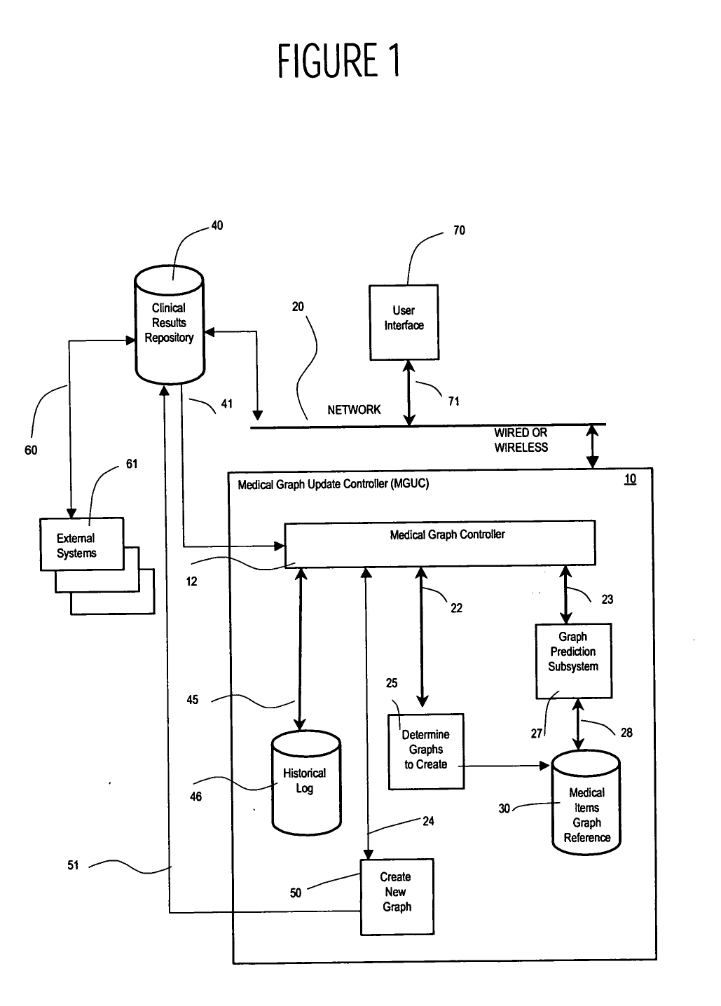

FIG. 1 shows a system for processing and graphing patient medical data and for accelerating patient medical information graph display by updating medical information graphs as a background process in response to the posting of medical information to a patient medical record. As an individual new result, observation or other information is received, associated graphs are updated in the background. Updated graph information is posted as a clinical result, for example, to a user display or a patient medical record. A user is shown an older graph together with an option button enabling the user to initiate update of the older graph to the latest version in response to a user request for a graph being received before background update has been completed. A prediction engine monitors requests for graphs and based on user-defined thresholds adds additional graphs to be updated using the background update process. The prediction engine also adds additional graphs to be updated using the background update process in response to an optional user configurable analysis of predetermined criteria.

Physicians, nurses and other healthcare clinicians and workers typically do not use graphs widely since the time required to render and display a graph exceeds the time a healthcare provider is willing to allocate to obtain a graph. The system provides graphs with reduced response time by creating the graphs in a background process independently of a request to initiate graph display. In this system, the graphs are stored as clinical data in a repository and updated as needed when new information becomes available. The system provides a fast response time for users, anticipates graph usage and creates graphs before they are requested by users. A user is able to enter an override command to initiate creation of a new graph if graph creation by the background process is not yet complete. While the information used by physicians and nurses is generally similar there do have role specific data graphing requirements. Nurses and other clinicians work directly with patients on a 24 hour a day basis so they have a larger graphing requirement for regular updates for routine observations such as vital signs, input and output and less requirements for larger overviews. The system creates routine operational graphs for nurses and overview types of graphs for physicians. Physicians usually spend less time with a patient and typically require a larger data overview.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display or user interface processor or generator is a known element comprising electronic circuitry or software or a combination of both for generating display images or portions thereof. A user interface comprises one or more display images enabling user interaction with a processor or other device.

In the FIG. 1 system, a patient medical parameter value may be posted to clinical data repository 40 from either external system 61 via communication link 60 or from an internal system with direct database access to clinical data repository 40. External system 61 may comprise an imaging modality (MRI, CT, X-ray, Ultrasound etc.) system, a nursing system, a scheduling system, an orders and laboratory results system, an ancillary system, a home healthcare system, and an electronic patient record. In response to a patient medical parameter value being posted to clinical data repository 40, a message is sent to the Medical Graph Update Controller 12 in graph update system 10 via communication link 41. The message sent to Controller 12 provides patient identification information as well as the data value, description and database key of the new patient medical parameter value. A record indicating acquisition of the new patient medical parameter value is logged in historical log 46 through communication interface 45. Controller 12 executes process 25, via interface 22, to determine if any graphs need to be created for the acquired new patient medical parameter value. Controller 12 executing process 25, examines database 30 to determine if the acquired new patient medical parameter value is associated with an indicator indicating a graph is to be created for the new patient medical parameter. Database 30 includes predetermined configuration information indicating a graph is to be pre-stored for particular acquired patient medical parameters and indicating the characteristics of the graphs (scale and timeline on x and y axes, frequency of graph creation and update, time of initiation of creation etc.).

Controller 12 takes no further action in connection with graph creation in response to determining from database 30 that no graph is to be created for the acquired new patient medical parameter. Controller 12 executes Create New Graph process 50 via interface 24 to create a graph in response to an examination of database 30 determining a graph is to be created for the new patient medical parameter. The graph is created to be compatible with characteristics such as x, y scale (timeline) number of data points, resolution, whether or not data points are combined (e.g., averaged) to compress data etc. derived from database 30. A created graph is stored in clinical data repository 40 via interface 51 and a previous graph for the new patient medical parameter stored in repository 40 is marked as out of date. Individual new graphs created and stored in clinical data repository 40 are stored as individual static images. Controller 12 removes and replaces an existing graph with a corresponding updated new graph in database 40, in response to detecting an out of date indicator being associated with the existing graph.

In response to a user request to access a graph entered via user interface 70, an access command message is communicated from user interface 70 via communication interface 71 and network 20 to clinical data repository 40. User interface 70 may be resident on a variety of different processing devices including, a PC, notebook, palm computer, workstation, mobile phone, tablet device, wireless processing device, pager and a patient medical imaging modality device, for example. A database management application managing access to repository 40 retrieves a created graph from clinical data repository 40 as an individual static image, for example, and communicates the image to user interface 70, for display, storage or printing. User interface system 70 includes an input device that permits a user to enter information and an output device that provides a user a display of a created graph and other information. Preferably, the input device is a keyboard and mouse, but also may be a touch screen or a microphone with a voice recognition program, for example. The output device is a display, but also may be a speaker, for example. The output device provides information to the user responsive to the input device receiving information from the user. The display presents a graph responsive to the user entering a request via a keyboard of user interface 70, for example.

Information acquired from clinical data repository 40 comprising a created graph such as a file, incorporates associated graph related information such as date and time of graph creation, number of points used in creating a graph, x,y scale definition, and an indicator indicating whether or not the graph is out of date. Such an out of date indicator indicates that later acquired patient medical data is available that has not been incorporated in the graph acquired from clinical data repository 40. User interface 70 initiates generation of data representing a web page incorporating a graph obtained from clinical data repository 40. In response to receiving a graph with an out of date indicator indicating the graph is current and is the latest version, user interface 70 incorporates a message in the web page to indicate to a user the graph is current and up to date. In response to receiving a graph with an out of date indicator indicating the graph is out of date and later acquired patient medical data is available that has not been incorporated in the graph, user interface 70 incorporates a link (e.g., a hyperlink) in the web page. The link is incorporated in the web page together with a message to indicate to the user that the currently presented graph is out of date and a user may initiate generation and display of an updated graph in response to selection of the link.

In response to user selection of the link incorporated in the web page, a command message is communicated from user interface 70 via communication interface 71 and network 20 to Controller 12 to initiate generation and display of an updated graph. Controller 12 executing process 25 via interface 22, initiates examination of database 30 to determine predetermined configuration information for use in creating a graph of a particular patient medical parameter associated with the user selected link. The predetermined configuration information indicates characteristics of the graph to be created such as, scale and timeline on x and y axes, frequency of graph creation and update, for example. Controller 12 executes Create New Graph process 50 via interface 24 to create a graph in response to an examination of database 30 and acquisition of predetermined configuration information for the graph of the patient medical parameter concerned. A created graph is stored in clinical data repository 40 via interface 51 to replace a previous graph and the out of date indicator is removed. The created graph is also communicated via network 20 and interface 71 for display to a user on user interface 70.

Graph prediction unit 27 communicating with controller 12 via interface 23, monitors graph requests from a user and determines if a requested graph is to be added to the Medical Items to be Graphed list retained in Reference database 30. Controller 12 executing process 25, examines the list in database 30 to determine if a graph is to be created for a patient medical parameter. Graph prediction unit 27 determines if an individual user requested graph of one or more patient parameters is to be added to the list in database 30 via interface 28 based on multiple criteria. Prediction unit 27 adds a graph to the list in database 30 based on user configured predetermined criteria or automatically derived criteria or default criteria. The criteria includes, for example, whether a graph is associated with a high priority care giver (i.e., a physician), a graph is in common usage, a graph shows interesting values or a graph involves a long response time for graph creation. Other criteria, includes whether a graph shows patient parameters outside a normal range or shows a critical patient condition, an unusual or undesirable combination of patient parameter values or a patient concerned is in critical condition.

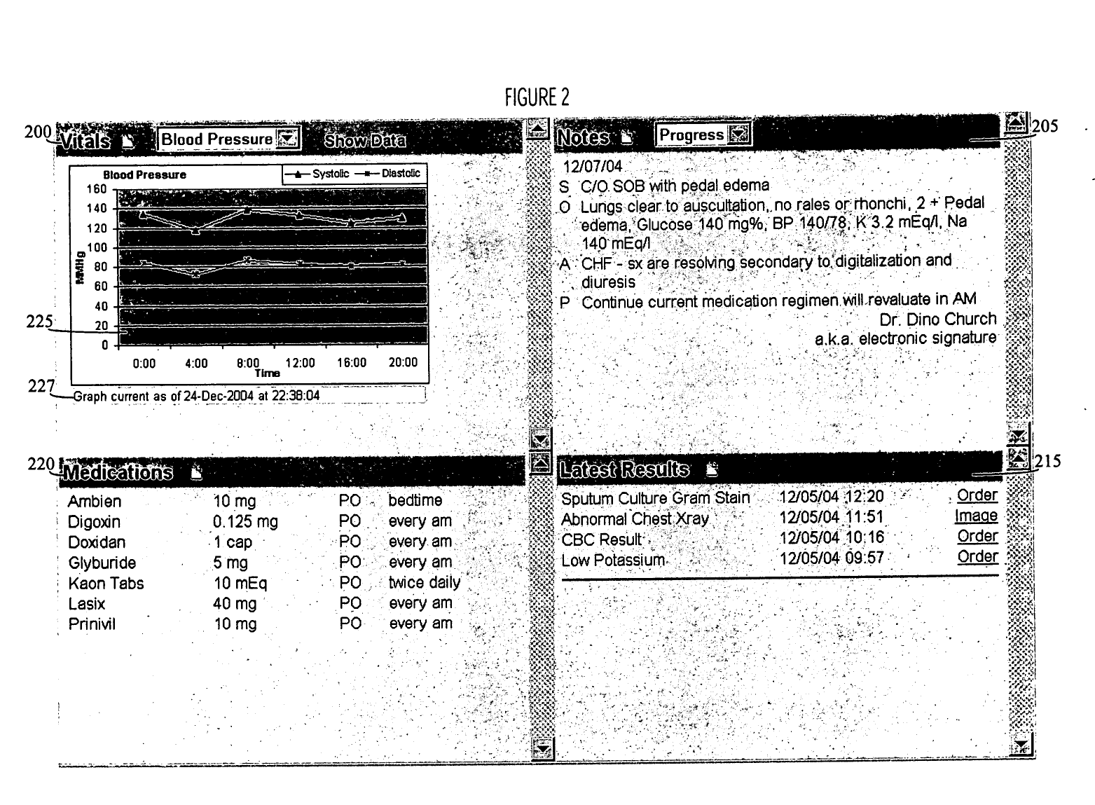

FIG. 2 shows a user interface image comprising a web page presenting a patient medical graph. The graph 225 is of patient blood pressure and is presented by user interface 70 in image vital signs display panel 200. Other image panels include medication information panel 220, latest laboratory result information panel 215 and patient diagnostic notes information panel 205. User interface 70 initiates generation of data representing the web page incorporating the graph 225 acquired from clinical data repository 40. User interface 70 incorporates message 227 in the web page indicating to a user the graph is current and up to date in response to receiving a graph with an out of date indicator indicating the graph is current and is the latest version. The message indicates specifically the date and time as of which the graph is current.

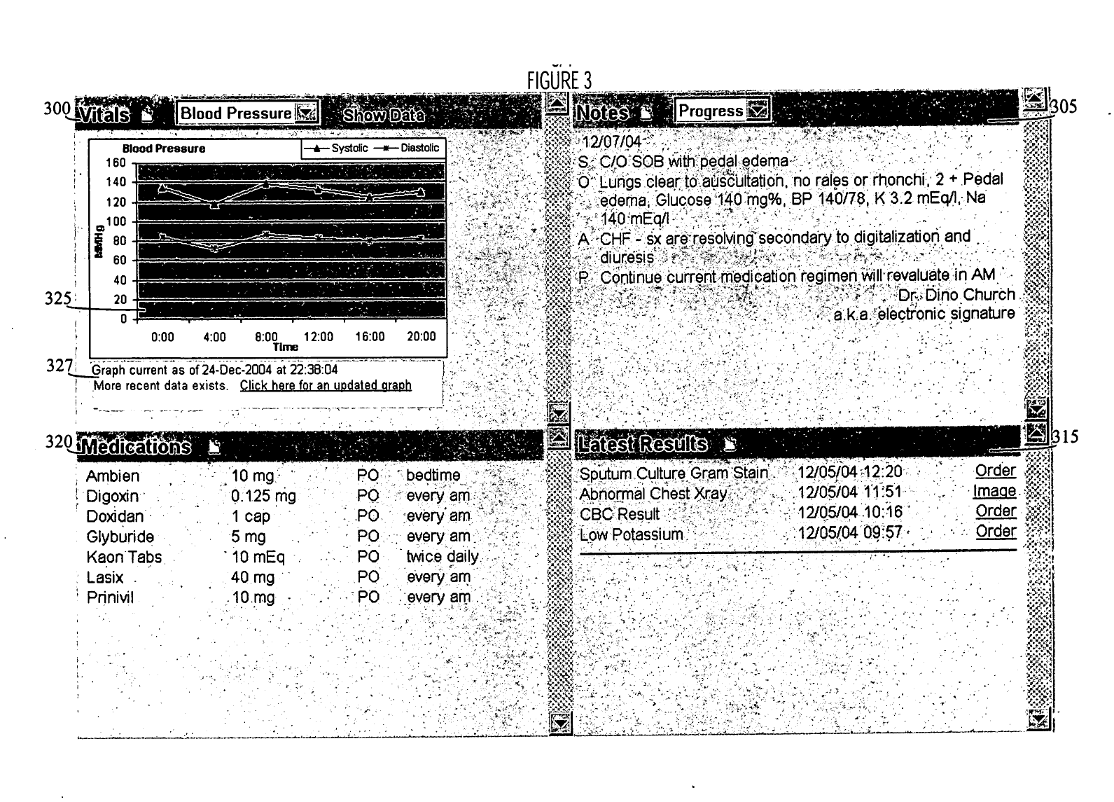

FIG. 3 shows a user interface image comprising a web page presenting a patient medical graph in the event that an up to date graph is unavailable. This occurs when a request to access a graph occurs before controller 12 has completed executing Create New Graph process 50 via interface 24 to create an updated graph in a background process. The process is performed in response to an examination by controller 12 of database 30 to determine whether a graph is to be created for acquired patient medical parameter data. In another embodiment, a user request to access a graph is intercepted by controller 12. In response, controller 12 initiates creation of the graph but requires a user to wait for completion of the graph creation process.

In the FIG. 3 image, graph 325 is of patient blood pressure and is presented by user interface 70 in image vital signs panel 300. Other image panels include medication information panel 320, latest laboratory result information panel 315 and patient diagnostic notes information panel 305. User interface 70 initiates generation of data representing the web page incorporating the graph 325 acquired from clinical data repository 40. User interface 70 incorporates a message and a link 327 (e.g., a hyperlink) in the web page. The link is incorporated in the web page together with the message to indicate to the user that the currently presented graph is out of date and a user may initiate generation and display of an updated graph in response to selection of the link. Message 327 also indicates the date and time as of which the out of date displayed graph is current.

In response to user selection of link 327 incorporated in the web page, a command message is communicated from user interface 70 via communication interface 71 and network 20 to Medical Graph Controller 12 to initiate generation and display of an updated graph. Controller 12 executes process 25 via interface 22 and initiates examination of database 30 to determine predetermined configuration information for use in creating a graph of a particular patient medical parameter associated with the user selected link. Controller 12 advantageously provides commonly used graphs with reduced delay to healthcare workers in response to multiple criteria employed by graph prediction system 27 to initiate pre-building of graphs.

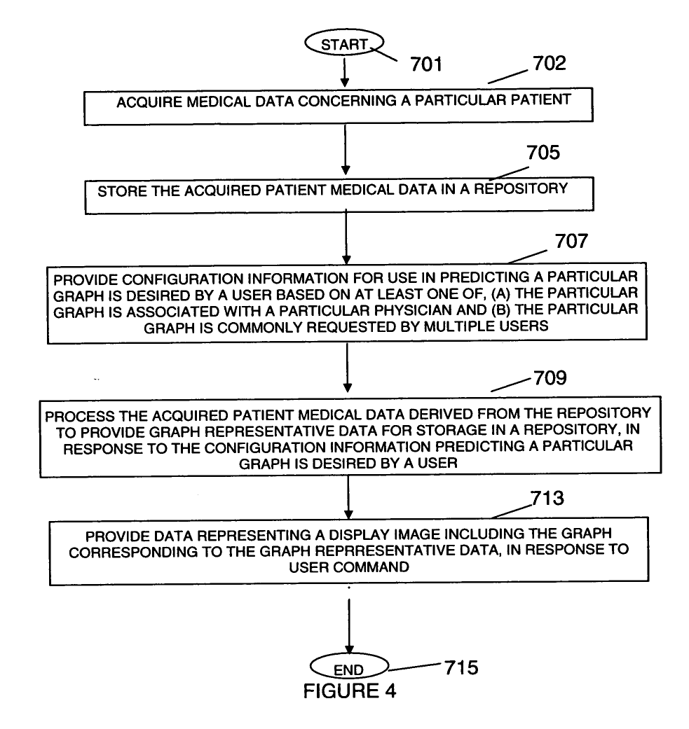

FIG. 4 shows a flowchart of a process performed by graph update system 10, user interface 70 and repository 40 for providing a patient medical graph. In steps 702 and 705 following the start at step 701, repository 40 acquires and stores medical data concerning a particular patient. In step 707, prediction processor 27 in system 10 provides configuration information for use in predicting that a particular graph is desired by a user and selects particular parameters of a particular patient for processing to provide the particular graph, in response to a prediction the particular graph is likely to be needed. Processor 27 performs a prediction based on configuration information comprising at least one of, (a) the particular graph is associated with a particular physician, (b) the particular graph is commonly requested by multiple users, (c) the particular graph involves a relatively long response time for generation, (d) the particular graph indicates values of interest to a physician, (e) the particular graph associated with a nurse or other clinician, (f) the particular graph indicates values of interest to the nurse. Processor 27 also performs a prediction based on configuration information comprising, a user preference profile, a user graph viewing history and a predetermined graphing probability. The configuration information also identifies one or more of, a particular graph, a particular patient and particular parameters for use in determining a particular graph is to be created and pre-stored ready for access by a user.

System 10 in step 709, processes the acquired patient medical data derived from repository 40 to provide graph representative data for storage (pre-caching) in repository 40 as a background process, in response to the configuration information predicting a particular graph is desired by a user. In step 713 user interface 70 provides data representing a display image including the graph corresponding to the graph representative data, in response to user command. The display image also includes an indicator identifying a graph of the acquired data comprising an updated version of a currently displayed graph is available for creation and presentation to a user and an indicator identifying a displayed pre-stored graph of the acquired data is out of date. In another embodiment, the display image includes an indicator identifying a pre-stored graph of the acquired data comprising an updated version of a currently displayed graph is available for presentation to a user. The process of FIG. 4 terminates at step 715. The process may comprise machine readable instruction incorporated in a tangible medium for execution by a processing device.

The system may be used by any organization that wants accelerated access to medical information graphs from comprehensive clinical repositories or lifetime clinical records. The system, process and user interface display images presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1 and 4, may be implemented in hardware, software or a combination of both.

What is claimed is:

1. A medical data graphing system, comprising:
a repository for storing patient medical data;
an acquisition processor for acquiring medical data concerning a particular patient and storing said acquired patient medical data in said repository;
a data processor for processing said acquired patient medical data derived from said repository to provide graph representative data for storage in a repository, in response to predetermined configuration information indicating a graph is to be pre-stored for said acquired patient medical data; and
a user interface processor for providing data representing a display image including a pre-stored graph in response to user command.

2. A system according to claim 1, including
a prediction processor for providing said configuration information by predicting a particular graph is desired by a user based on at least one of, (a) said particular graph is associated with a particular physician and (b) said particular graph is commonly requested by multiple users.

3. A system according to claim 1, including
a prediction processor for providing said configuration information by predicting a particular graph is desired by a user based on at least one of, (a) said particular graph involves a relatively long response time for generation and (b) said particular graph indicates values of interest to a physician.

4. A system according to claim 1, including
a prediction processor for providing said configuration information by predicting a particular graph is desired by a user based on at least one of, (a) a user preference profile, (b) a user graph viewing history and (c) a predetermined graphing probability.

5. A system according to claim 1, wherein
said user interface processor provides data representing a display image including an indicator identifying a pre-stored graph of said acquired data is available for presentation to a user.

6. A system according to claim 1, wherein
said user interface processor provides data representing a display image including an indicator identifying a pre-stored graph of said acquired data comprising an updated version of a currently displayed graph is available for presentation to a user.

7. A system according to claim 1, wherein
said user interface processor provides data representing a display image including an indicator identifying a displayed pre-stored graph of said acquired data is out of date.

8. A system according to claim 1, wherein
said data processor selectively processes said acquired data derived from said repository to provide graph representative data for a particular graph of particular parameters for pre-caching in a repository as a background process.

9. A system according to claim 8, wherein
said data processor selects particular parameters of a particular patient for processing to provide said particular graph in response to a prediction said particular graph is likely to be needed.

10. A system according to claim 9, including
a prediction processor for selecting particular parameters of a particular patient for processing to provide said particular graph based on at least one of, (a) said particular graph involves a relatively long response time for generation and (b) said particular graph indicates values of interest to a physician.

11. A system according to claim 9, including
a prediction processor for selecting particular parameters of a particular patient for processing to provide said particular graph based on at least one of, (a) a user preference profile, (b) a user graph viewing history and (c) a predetermined graphing probability.

12. A system according to claim 9, including
a prediction processor for selecting particular parameters of a particular patient for processing to provide said particular graph based on a role of a user.

13. A system according to claim 9, including
a prediction processor for selecting particular parameters of a particular patient for processing to provide said particular graph based on at least one of, (a) said particular graph is associated with a particular physician and (b) said particular graph is commonly requested by multiple users.

14. A system according to claim 1, wherein
said predetermined configuration information indicates a particular graph is to be created and pre-stored for particular parameters of a particular patient.

15. A system according to claim 1, wherein
said predetermined configuration information identifies at least one of, (a) a particular graph, (b) a particular patient and (c) particular parameters for use in determining a particular graph is to be created and pre-stored ready for access by a user.

16. A medical data graphing system, comprising:
a repository for storing patient medical data;
an acquisition processor for acquiring medical data concerning a particular patient and storing said acquired patient medical data in said repository;
a prediction processor for providing configuration information for use in predicting a particular graph is desired by a user based on at least one of, (a) said particular graph is associated with a particular physician and (b) said particular graph is commonly requested by multiple users.
a data processor for processing said acquired patient medical data derived from said repository to provide graph representative data for storage in a repository, in response to said configuration information predicting a particular graph is desired by a user; and
a user interface processor for providing data representing a display image including a graph corresponding to the graph representative data, in response to user command.

17. A method for providing patient medical data graphs, comprising the activities of:
acquiring medical data concerning a particular patient;
storing said acquired patient medical data in said repository;
processing said acquired patient medical data derived from said repository to provide graph representative data for storage in a repository, in response to predetermined configuration information indicating a graph is to be pre-stored for said acquired patient medical data; and
a user interface processor for providing data representing a display image including a pre-stored graph in response to user command.

18. A tangible medium storing machine readable instruction for execution by a processing device in performing the method of claim 17.
